(19) United States
(12) Patent Application Publication
(10) Pub. No.: US 2006/0221251 A1
(43) Pub. Date: Oct. 5, 2006

(54) DISPLAY, ARRAY SUBSTRATE, AND METHOD OF MANUFACTURING DISPLAY

(76) Inventors: Kazuyoshi Omata, Fukaya-shi (JP); Makoto Shibusawa, Fukaya-shi (JP); Yoshiro Aoki, Kitamoto-shi (JP); Hiroshi Nakayama, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/277,580

(22) Filed: Mar. 27, 2006

(30) Foreign Application Priority Data
Mar. 31, 2005 (JP) 2005-104650
Jun. 29, 2005 (JP) 2005-189904

(51) Int. Cl. H04N 9/77

(52) U.S. Cl. 348/664

(57) ABSTRACT

A display includes an insulating substrate, a video signal line placed on a main surface of the insulating substrate and including first and second ends, pixels connected to the video signal line, a video signal line driver to which the first end is connected, an inspection signal line placed near the second end and including third and fourth ends, the third end being located at an edge of the main surface, and an analog switch connected between the second and fourth ends.

### CROSS-REFERENCE TO RELATED APPLICATIONS

This application is based upon and claims the benefit of priority from prior Japanese Patent Applications No. 2005-104650, filed Mar. 31, 2005; and No. 2005-189904, filed Jun. 29, 2005, the entire contents of both of which are incorporated herein by reference.

### BACKGROUND OF THE INVENTION

1. Field of the Invention

The present invention relates to a display, an array substrate, and a method of manufacturing a display.

2. Description of the Related Art

U.S. Pat. No. 6,373,454 describes an active matrix organic (electroluminescent) EL display in which each pixel circuit employs a current mirror circuit. According to the display, each pixel is supplied with a current signal as a video signal to make an organic EL element emit light at luminance corresponding to the magnitude of the video signal.

In a manufacturing process of an active matrix organic EL display, a dynamic operating inspection is normally performed prior to connecting a video signal line driver and scan signal line driver to a display panel. Specifically, the pixels are supplied with inspection signals, which are equal in magnitude, to determine whether a dot-like or line-like luminance unevenness occurs on a displayed image. Then, if necessary, a repair process is performed on each pixel that causes the display unevenness.

When the above dynamic operating inspection is performed on an organic EL display in which each pixel is supplied with a current signal as the video signal, a current signal is utilized as the inspection signal. Therefore, in the dynamic operating inspection, video signal lines need to be electrically disconnected from one another.

However, a distance between outer lead bonding (OLB) pads for connecting a video signal line driver to video signal lines is generally short, for example, about several tens of micrometers. Thus, when the OLB pads are utilized as inspection signal input terminals, hard contact pins cannot be used as inspection signal output terminals of an inspection apparatus. Consequently, there is no other choice but to use a flat board probe (or a film probe) that is expensive and low in durability.

### BRIEF SUMMARY OF THE INVENTION

According to a first aspect of the present invention, there is provided a display comprising an insulating substrate, a video signal line placed on a main surface of the insulating substrate and including first and second ends, pixels connected to the video signal line, a video signal line driver to which the first end is connected, an inspection signal line placed near the second end and including third and fourth ends, the third end being located at an edge of the main surface, and an analog switch connected between the second and fourth ends.

According to a second aspect of the present invention, there is provided a display comprising an insulating substrate, a video signal line placed on a main surface of the insulating substrate and including first and second ends, pixels connected to the video signal line, a video signal line driver to which the first end is connected, and a resistance element placed near the second end and including first and second terminals, the first terminal being connected to the second end, and the second terminal being located at an edge of the main surface.

According to a third aspect of the present invention, there is provided an array substrate comprising an insulating substrate, a video signal line placed on a main surface of the insulating substrate and including first and second ends, pixel circuits connected to the video signal line, an OLB pad connected to the first end, an inspection signal line including third and fourth ends, a first inspection pad connected to the third end, and an analog switch connected between the second and fourth ends.

According to a fourth aspect of the present invention, there is provided an array substrate comprising an insulating substrate, a video signal line placed on a main surface of the insulating substrate and including first and second ends, pixel circuits connected to the video signal line, an OLB pad connected to the first end, an inspection pad, and a resistance element connected between the second end and the inspection pad.

According to a fifth aspect of the present invention, there is provided a method of manufacturing a display, comprising preparing the array substrate according the third aspect, forming pixels including the pixel circuits, inspecting the pixels by supplying the first inspection pad with an inspection signal while closing the analog switch, and breaking the array substrate along a break line which intersects the inspection signal line and is spaced apart from the analog switch and the video signal line.

According to a sixth aspect of the present invention, there is provided a method of manufacturing a display, comprising preparing the array substrate according to the fourth aspect, forming pixels including the pixel circuits, inspecting the pixels by supplying the inspection pad with an inspection signal, and breaking the array substrate along a break line which intersects the resistance element.

### BRIEF DESCRIPTION OF THE SEVERAL VIEWS OF THE DRAWING

FIG. 1 is a plan view schematically showing a display according to a first embodiment of the present invention;

FIG. 2 is a sectional view schematically showing an example of a structure that can be used in the display shown in FIG. 1;

FIG. 3 is a plan view schematically showing an example of an array substrate that can be used to manufacture the display shown in FIG. 1;

FIG. 4 is a plan view schematically showing a part of a display according to a second embodiment of the present invention;

FIG. 5 is a plan view schematically showing an example of an array substrate that can be used to manufacture the display shown in FIG. 4;

FIG. 6 is a plan view schematically showing a part of a display according to a third embodiment of the present invention; and

FIG. 7 is a plan view schematically showing an example of an array substrate that can be used to manufacture the display shown in FIG. 6.

### DETAILED DESCRIPTION OF THE INVENTION

Embodiments of the present invention will be described below in detail with reference to the drawings. In the drawings, components having similar functions are denoted by the same reference characters and duplicate descriptions will be omitted.

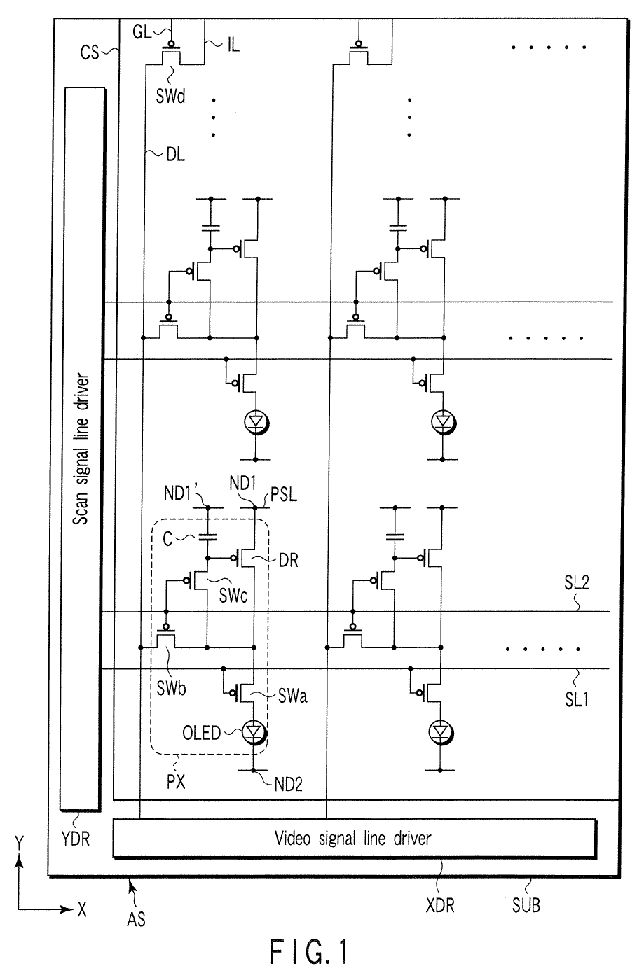

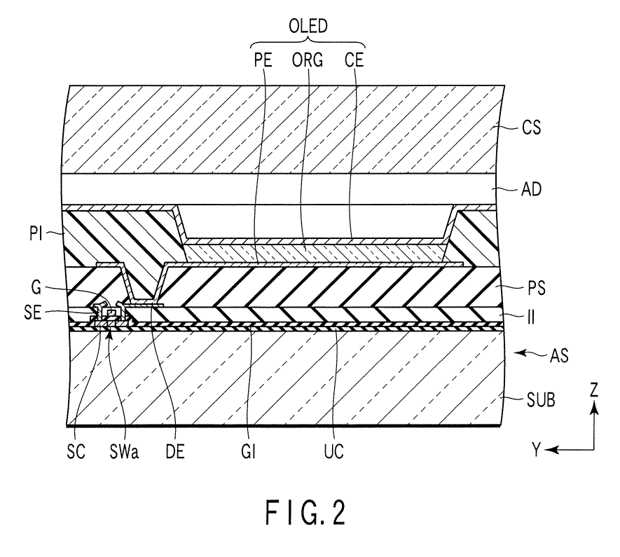

FIG. 1 is a plan view schematically showing a display according to a first embodiment of the present invention. FIG. 2 is a sectional view schematically showing an example of a structure that can be used in the display shown in FIG. 1. In FIG. 1, the sealing layer AD is omitted. In FIG. 2, the display is drawn so that its display surface, that is, its front surface or light emitting surface faces the bottom of the drawing, while its back surface faces the top of the drawing.

This display is a bottom emission organic EL display that employs an active matrix driving method. The organic EL display includes an array substrate AS, sealing substrate CS, sealing layer AD, video signal line driver XDR, and scan signal line driver.

The array substrate AS includes an insulating substrate SUB such as glass substrate.

For example, an SiNₓ layer and an SiOₓ layer are sequentially stacked on the substrate SUB as an undercoat layer UC shown in FIG. 2.

Semiconductor layers SC such as polysilicon layers are arranged on the undercoat layer UC. Source and drain are formed in each polysilicon layer SC.

The undercoat layer UC and semiconductor layers SC are covered with a gate insulator GI. The gate insulator GI can be made from tetraethyl orthosilicate (TEOS), for example.

Gates G are arranged on the gate insulator GI. The gates G are made of MoW, for example.

The semiconductor layers SC, gate insulator GI, and gates G form top-gate type thin-film transistors. In the present embodiment, the thin-film transistors are utilized as drive control elements DR and switches SWa to SWc included in pixels PX and switches SWd shown in FIG. 1.

On the gate insulator GI, scan signal lines SL1 and SL2 and gate lines GL shown in FIG. 1 and bottom electrodes (not shown) are further arranged. These components can be formed in the same process as that for forming the gates G.

As shown in FIG. 1, the scan signal lines SL1 and SL2 extend along the rows of the pixels PX, i.e., in an X direction, and are arranged in a Y direction along the columns of the pixels PX. The scan signal lines SL1 and SL2 are connected to the scan signal line driver YDR.

As an example, the gate lines GL extend in the Y direction and are arranged in the X direction correspondently with video signal lines DL described later. An end of each gate line GL is located at an edge of the insulating substrate SUB.

The bottom electrodes are connected to the gate of the drive control elements DR. Each bottom electrode is utilized as an electrode of a capacitor C described later.

An interlayer insulating film II shown in FIG. 2 covers the gate insulator GI, gates G, scan signal lines SL1 and SL2, and bottom electrodes. The interlayer insulating film II is, for example, an SiOₓ film formed by plasma CVD. Parts of the interlayer insulating film II are utilized as dielectric layers of the capacitors C.

On the interlayer insulating film II, source electrodes SE and drain electrodes DE shown in FIG. 2, video signal lines DL, inspection signal lines IL, and power supply lines PSL shown in FIG. 1, and top electrodes (not shown) are arranged. These components can be formed in the same process and may have a three-layer structure of, for example, Mo, Al, and Mo.

The source electrodes SE and drain electrodes DE are electrically connected to the sources and drains of the thin-film transistors via contact holes formed in the interlayer insulting film II.

As shown in FIG. 1, the video signal lines DL extend in the Y direction and are arranged in the X direction. An end of each video signal line DL is connected to a video signal line driver XDR.

The inspection signal lines IL are arranged correspondently with the video signal lines DL near the other ends of the video signal lines DL. An end of each inspection line IL is located at an edge of the insulating substrate SUB.

As an example, the power supply lines PSL extend in the Y direction and are arranged in the X direction. For example, the power supply lines PSL are connected to the video signal line driver XDR.

The top electrodes are connected to the power supply lines PSL. Each top electrode is utilized as another electrode of the capacitor C.

A passivation film PS shown in FIG. 2 covers the source electrodes SE, drain electrodes DE, video signal lines DL, inspection signal lines IL, power supply lines PSL, and top electrodes. The passivation film PS is made of, for example, SiNₓ.

First electrodes PE as pixel electrodes are arranged on the passivation film PS. In the present embodiment, the first electrodes PE are light-transmissible front electrodes. Each first electrode PE is connected through a through-hole formed in the passivation film PS to the drain electrode DE to which the drain of the switch SWa is connected.

In this embodiment, the first electrodes PE are anodes. Transparent conductive oxides, for example, indium tin oxide (ITO) can be used as a material of the first electrodes PE.

A partition insulating layer PI shown in FIG. 2 is further placed on the passivation film PS. The partition insulating layer PI has through-holes formed at positions corresponding to the first electrodes PE or slits formed at positions corresponding to columns or rows formed by the first electrodes PE. Here, by way of example, the partition insulating layer PI has through-holes formed at positions corresponding to the first electrodes PE.

The partition insulating layer PI is, for example, an organic insulating layer. The partition insulating layer PI can be formed using, for example, a photolithography technique.

An organic layer ORG as an active layer including an emitting layer is placed on each of the first electrodes PE. The emitting layer is, for example, a thin film containing a luminescent organic compound that emits red, green, or blue light. In addition to the emitting layer, the organic layer ORG may include a hole injection layer, a hole transporting layer, a hole blocking layer, an electron transporting layer, and an electron injection layer.

The partition insulating layer PI and the organic layer ORG are covered with a second electrode CE as a counter electrode. The second electrode CE is a common electrode shared among the pixels PX. In this embodiment, the second electrode CE is a light-reflective cathode serving as a back electrode. For example, an electrode wire (not shown) is formed on the layer on which the video signal lines DL are formed, and the second electrode CE is electrically connected to the electrode wire via a contact hole formed in the passivation film PS and partition insulating layer PI. Each organic EL element OLED includes the first electrode PE, organic layer ORG, and second electrode CE.

As shown in FIG. 1, each pixel PX includes an organic EL element OLED, drive control element (drive transistor) DR, output control switch SWa, selector switch SWb, diode-connecting switch SWc, and capacitor C. As described above, in the present embodiment, the drive control element DR and switches SWa to SWd are p-channel thin-film transistors. The selector switch SWb and diode-connecting switch SWc form a switch group which switches between a first state that the drain and gate of the drive control element DR and the video signal line D1 are connected to one another and a second state that they are disconnected from one another.

The drive control element DR, output control switch SWa, and organic EL element OLED are connected in series between a first power supply terminal ND1 and second power supply terminal ND2 in this order. In this embodiment, the first power supply terminal ND1 is a high-potential power supply terminal, and the second power supply terminal ND2 is a low-potential power supply terminal.

The gate of the output control switch SWa is connected to the scan signal line SL1. The selector switch SWb is connected between the video signal line DL ad the drain of the drive control element DR. The gate of the switch SWb is connected to the scan signal line SL2. The diode-connecting switch SWc is connected between the drain and gate of the drive control element DR. The gate of the switch SWc is connected to the scan signal line SL2.

The capacitor C is connected between the gate of the drive control element DR and a constant-potential terminal ND1′. As an example, the constant-potential terminal ND1′ is connected to the first power supply terminal ND1.

Analog switches SWd are connected between the video signal lines and the inspection signal lines, each of which has an end located at the edge of the substrate SUB. As described above, in the present embodiment, the switches SWd are p-channel thin-film transistors.

Note that the structure including the insulating substrate SUB, partition insulating layer PI, and components interposed therebetween corresponds to an array substrate after broken.

The sealing substrate CS faces the second electrode CE. The sealing substrate is generally smaller in size than the array substrate AS. As the sealing substrate CS, for example, a glass substrate can be used.

The sealing layer AD has a frame shape and is interposed between peripheries of opposed surfaces of the array substrate AS and sealing substrate CS. As a material of the sealing layer AD, for example, an adhesive can be used. The sealing layer AD form a gas tight space between the array substrate AS and sealing substrate CS. The space is filled with, for example, an inert gas or resin.

The video signal line driver XDR and scan signal line driver YDR are placed on uncovered regions of a main surface of the array substrate AS on the side of the sealing substrate CS which is not covered with the sealing substrate CS. That is, the video signal line driver XDR and scan signal line driver YDR are mounted by chip-on-glass (COG) in the present embodiment. The video signal line driver XDR and scan signal line driver YDR may be mounted by tape carrier package (TCP) instead.

When an image is to be displayed on the organic EL display, both the scan signal lines SL1 and the scan signal lines SL2 are driven sequentially, for example. In a write period for writing a video signal on a pixel PX, the scan signal line driver YDR outputs a scan signal for opening (or switching off) the switch SWa as a voltage signal to the scan signal line SL1 to which the pixel PX is connected, and subsequently, outputs a scan signal for closing (or switching on) the switches SWb and SWc as a voltage signal to the scan signal line SL2 to which the pixel PX is connected. In this state, the video signal line driver XDR outputs a video signal as a current signal to the video signal line DL to which the pixel PX is connected, so as to set the gate-to-source voltage of the drive control element DR at a value corresponding to the magnitude of the video signal. Then, the scan signal line driver YDR outputs a scan signal for opening (or switching off) the switches SWb and SWc as a voltage signal to the scan signal line SL2 to which the pixel PX is connected, and subsequently, outputs a scan signal for closing (or switching on) the switch SWa as a voltage signal to the scan signal line SL1 to which the pixel is connected.

During an effective display period over which the switch SWa is open, a drive current flows through the organic EL element OLED at magnitude corresponding to the gate-to-source voltage of the drive control element DR. The organic EL element OLED emits light at luminance corresponding to the magnitude of the drive current.

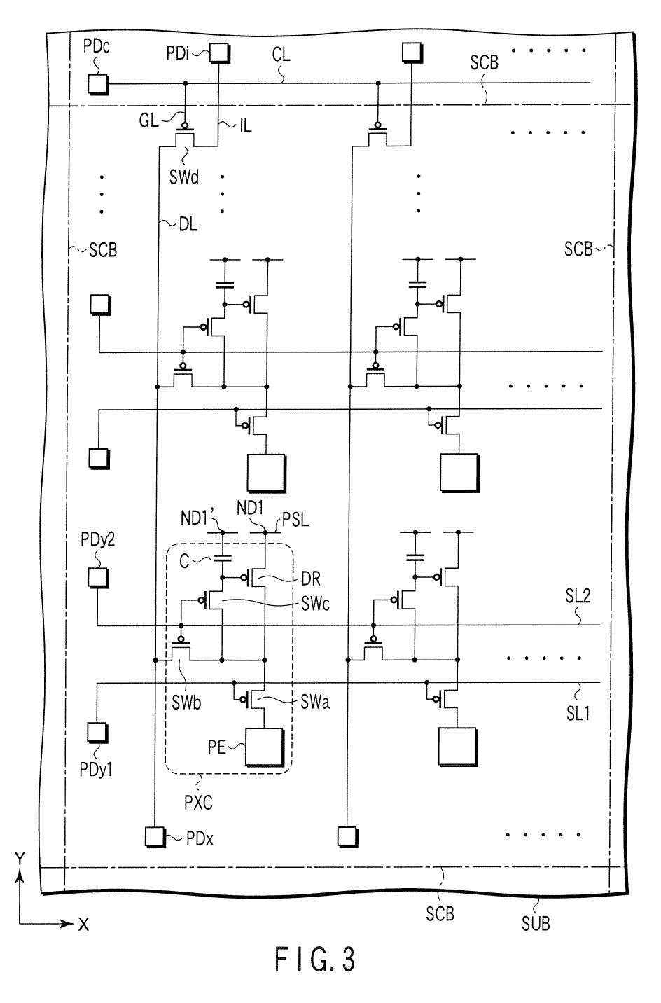

FIG. 3 is a plan view schematically showing an example of an array substrate that can be used to manufacture the display shown in FIG. 1. The array substrate AS shown in FIGS. 1 and 2 can be obtained by forming a plurality of structures described in connection with this array substrate AS on a large substrate, and then breaking the large substrate into a plurality of pieces. FIG. 3 shows the unbroken array substrate. In FIG. 3, PXC denotes a pixel circuit, CL denotes a control line CL, PD_{c} and PDᵢ denote inspection pads, PDₓ, PD_{y}1, and PD_{y}2 denote OLB pads, and SCB denotes a breaking line. The array substrate AS shown in FIG. 1 corresponds to a structure obtained by breaking the array substrate shown in FIG. 3 along the breaking lines SCB.

The OLB pads PDₓ, PD_{y}1, and PD_{y}2 are arranged on a part (hereinafter referred to as the “inside of the breaking lines SCB”) of the array substrate in FIG. 3 which is surrounded by the breaking lines SCB and on which the pixel circuits PXC, scan signal lines SL1 and SL2, video signal lines DL, power supply lines PSL, and switches SW_{d} are arranged. The OLB pads PDₓ are connected to the video signal lines DL. The OLB pads PD_{y}1 and PD_{y}2 are connected to the scan signal lines SL1 and SL2. The OLB pads (not shown) connected to the power supply lines PSL are further placed on the inside of the breaking lines SCB and in the vicinity of the OLB pads PDₓ.

The inspection pads PD_{c} and PDᵢ and the control line CL are arranged on a part (hereinafter referred to as the “outside of the breaking lines SCB”) of the array substrate in FIG. 3 which is different from the inside of the breaking lines SCB. The inspection pad PD_{c} is connected to the control line CL. The inspection signal lines IL and the gate lines GL cross the breaking lines SCB. The inspection pads PDᵢ and the control line CL are connected to the inspection signal lines IL and the gate lines GL, respectively, on the outside of the breaking lines SCB. The control line CL can be formed in the same process as that for forming the scan signal lines SL1 and SL2.

When the array substrate shown in FIG. 3 is used, the organic EL display shown in FIGS. 1 and 2 can be manufactured by, for example, the following method.

Firstly, the array substrate shown in FIG. 3 is prepared, and the organic layers ORG and second electrode CE are sequentially formed on the first electrodes PE. Subsequently, the array substrate shown in FIG. 3 and the sealing substrate CS shown in FIGS. 1 and 2 are laminated together via the sealing layer AD in an inert gas, for example. Then, the following dynamic operating inspection is performed on the resultant structure.

Scan signal output terminals of an inspection apparatus are brought into contact with the OLB pads PD_{y}1 and PD_{y}2, and a control signal output terminal of the inspection apparatus is brought into contact with the inspection pad PD_{c}. Further, inspection signal output terminals of the inspection apparatus are brought into contact with the inspection pads PDᵢ. As the output terminals of the inspection apparatus, hard contact pins may be used.

Subsequently, the inspection apparatus supplies the inspection pad PD_{c} with a control signal for closing the switch SWd. Then, the inspection apparatus supplies all the pixels PX with inspection signals which are equal in magnitude to one another.

Specifically, both the scan signal lines SL1 and the scan signal lines SL2 are driven sequentially. During a write period for writing an inspection signal on a pixel PX, the inspection apparatus outputs a scan signal for opening the switch SWa as a voltage signal to the OLB pad PD_{y}1 to which the pixel PX is connected, and subsequently, outputs a scan signal for closing the switches SWb and SWc as a voltage signal to the OLB pad PD_{y}2 to which the pixel PX is connected. In this state, the inspection apparatus outputs an inspection signal as a current signal to the inspection pad PDᵢ to set the gate-to-source voltage of the drive control element DR at a value corresponding to the magnitude of the inspection signal. Then the inspection apparatus outputs a scan signal for opening the switches SWb and SWc as a voltage signal to the OLB pad PD_{y}2 to which the pixel PX is connected, and subsequently, outputs a scan signal for closing the switch SWa as a voltage signal to the OLB pad PD_{y}1 to which the pixel PX is connected.

During an effective display period, a drive current flows through the organic EL element OLED at magnitude corresponding to the gate-to-source voltage of the drive control element DR. The organic EL element OLED emits light at luminance corresponding to the magnitude of the drive current.

An image is displayed by the above method to determine whether a dot-like or line-like luminance unevenness occurs on the displayed image.

As described above, the inspection signals are equal in magnitude to one another. Thus, if a breaking of wire or short-circuit occurs on none of the pixels PX, the organic EL elements OLED of all the pixels PX should emit light at an equal luminance. Consequently, when a dot-like or line-like luminance unevenness does not occur on a displayed image, it is judged that neither breaking of wire nor short-circuit occurs on the pixels PX, and the array substrate AS is broken along the breaking lines SCB.

When a dot-like or line-like luminance unevenness occurs on a displayed image, a repair process is performed on each pixel that causes the display unevenness, if necessary. For example, when a certain pixel PX is viewed as a luminous dot, a conductive path connecting the first power supply terminal ND1 to the second power supply terminal ND2 in the pixel PX is broken by laser beam irradiation. After the repair process, the array substrate AS is broken along the breaking lines SCB.

Then, the video signal line driver XDR and scan signal line driver YDR are mounted on the broken array substrate AS. That is, output terminals of the video signal line driver XDR are connected to the OLB pads PDₓ and an OLB pad (not shown) connected to the power supply lines PSL, and output terminals of the scan signal line driver YDR are connected to the OLB pads PD_{y}1 and PD_{y}2. The display shown in FIGS. 1 and 2 is thus obtained.

According to the manufacturing method, the inspection pads PDᵢ are arranged on the outside of the breaking lines SCB. The inspection signals are fed to the inspection pads PDᵢ.

As described above, a distance between the OLB pads PDₓ is short, for example, about several tens of micrometers. Thus, when the OLB pads PDₓ are utilized as inspection signal input terminals, hard contact pins cannot be used as inspection signal output terminals of an inspection apparatus.

Since the inspection pads PDᵢ are arranged on the outside of the breaking lines SCB, they can be laid out with a much higher degree of flexibility as compared with the OLB pads PDₓ. Therefore, the distance between the inspection pads PDᵢ can be about several hundreds of micrometers. Consequently, hard contact pins can be used as inspection signal output terminals of an inspection apparatus.

When the inspection pads PDᵢ are arranged on the outside of the breaking lines SCB, the inspection signal lines IL connected to the inspection pads PDᵢ are located in the vicinity of an end surface of the broken array substrate AS. If the inspection signal lines IL and the video signal lines DL are directly connected together, electrostatic damage of the pixels PX is likely to occur.

In contrast, in the present embodiment, the inspection signal lines IL and the video signal lines DL are connected together via the analog switches SWd. The breaking is carried out so that the resulting array substrate AS includes the analog switches SWd. In the resulting array substrate AS, the analog switches SWd serve as resistance elements. Therefore, according to this structure, electrostatic damage of the pixels PX is less prone to occur.

A second embodiment of the present invention will be described.

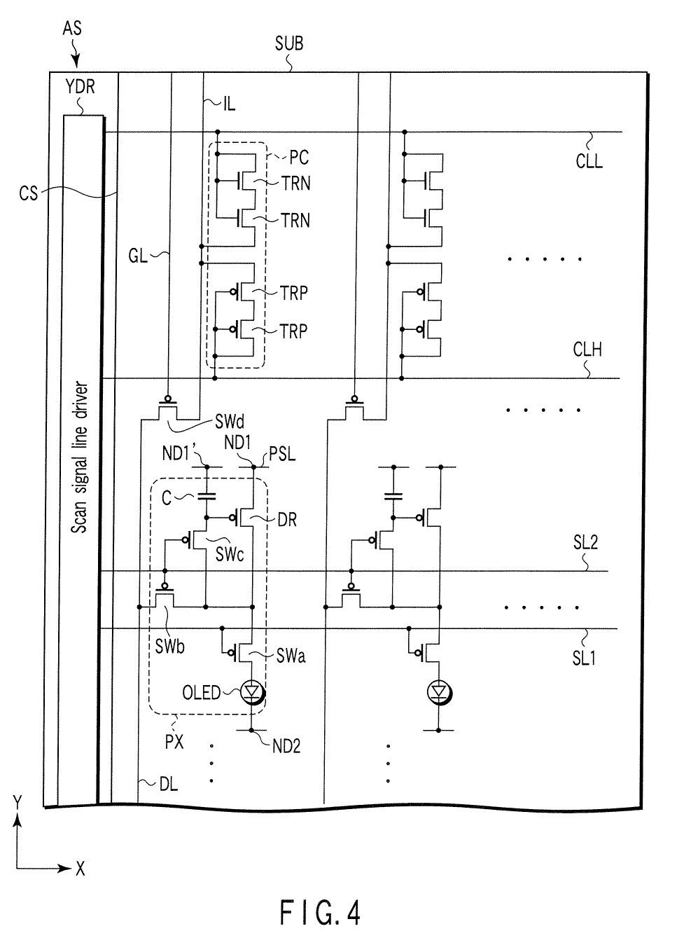

FIG. 4 is a plan view schematically showing a part of a display according to a second embodiment of the present invention.

This display is a bottom emission organic EL display employing an active matrix driving method. The organic EL display has the same structure as that of the organic EL display shown in FIGS. 1 and 2 except that the array substrate AS further includes a low-potential line CLL, high-potential line CLH, and protection circuits PC.

The low-potential line CLL and high-potential line CLH extend in the X direction and are arranged in the Y direction. These control lines CLL and CLH are connected to the scan signal line driver YDR. The control lines CLL and CLH can be formed in the same process as that for forming the scan signal lines SL1 and SL2.

The protection circuits PC are arranged correspondently with the inspection signal lines IL. The protection circuits PC are placed between the analog switches SWd and an edge of the substrate SUB. For example, the protection circuits PC are placed between the analog switches SWd and the inspection pads PDᵢ in the unbroken array substrate AS. Each protection circuit PC includes a p-channel thin-film transistor TRP and n-channel thin-film transistor TRN as field-effect transistors. In the present embodiment, each protection circuit PC includes two p-channel thin-film transistors TRP and two n-channel thin-film transistors TRN.

The p-channel thin-film transistors TRP are connected in series between the inspection signal line IL and the high-potential line CLH. The gates of the p-channel thin-film transistors TRP are connected to the high-potential line CLH. The p-channel thin-film transistors TRP form a diode that allows a forward current to flow from the inspection signal line IL to the high-potential line CLH.

The n-channel thin-film transistors TRN are connected in series between the inspection signal line IL and the low-potential line CLL. The gates of the n-channel thin-film transistors TRN are connected to the low-potential line CLL. The n-channel thin-film transistors TRN form a diode that allows a forward current to flow from the low-potential line CLL to the inspection signal line IL.

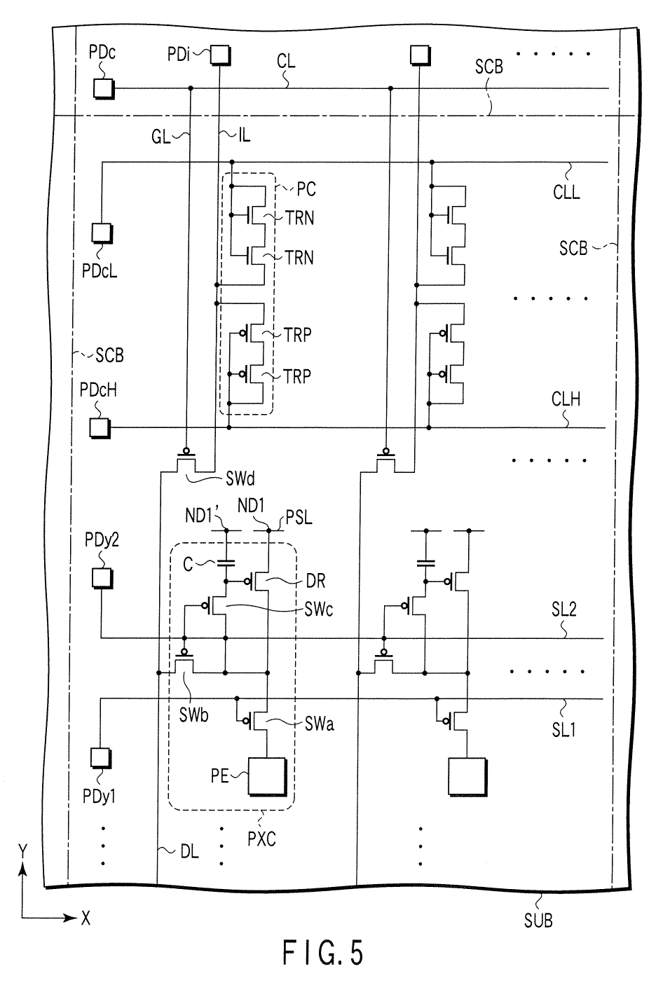

FIG. 5 is a plan view schematically showing an example of an array substrate that can be used to manufacture the display shown in FIG. 4. FIG. 5 shows an unbroken array substrate. In FIG. 5, PD_{c}L and PD_{c}H denote OLB pads. The array substrate AS shown in FIG. 4 is obtained by breaking the array substrate shown in FIG. 5, along the breaking lines SCB.

The OLB pads PD_{c}L and PD_{c}H are arranged on the inside of the breaking lines SCB. The OLB pad PD_{c}L is connected to the low-potential line CLL. The OLB pad PD_{c}H is connected to the high-potential line CLH.

The display in FIG. 4 can be manufactured by a method similar to that described with reference to FIGS. 1 to 3 except that the array substrate shown in FIG. 5 is used. Therefore, according to the present embodiment, the same effects as that described in the first embodiment can be achieved.

In the present embodiment, the protection circuits PC are connected to the inspection signal lines IL. Consequently, according to the present embodiment, the electrostatic damage of the pixels PX is less prone to occur as compared with the first embodiment. In particular, when the protection circuits PC are located between the analog switches SWd and the edge of the substrate SUB, the protection circuits PC can be formed larger, thus the electrostatic damage of the pixels PX is less prone to occur as compared with the case where other arrangement is employed.

In the first and second embodiment, p-channel field-effect transistors are used as the analog switches SWd. Instead, n-channel field-effect transistors may be used as the analog switches SWd.

A third embodiment of the present invention will be described.

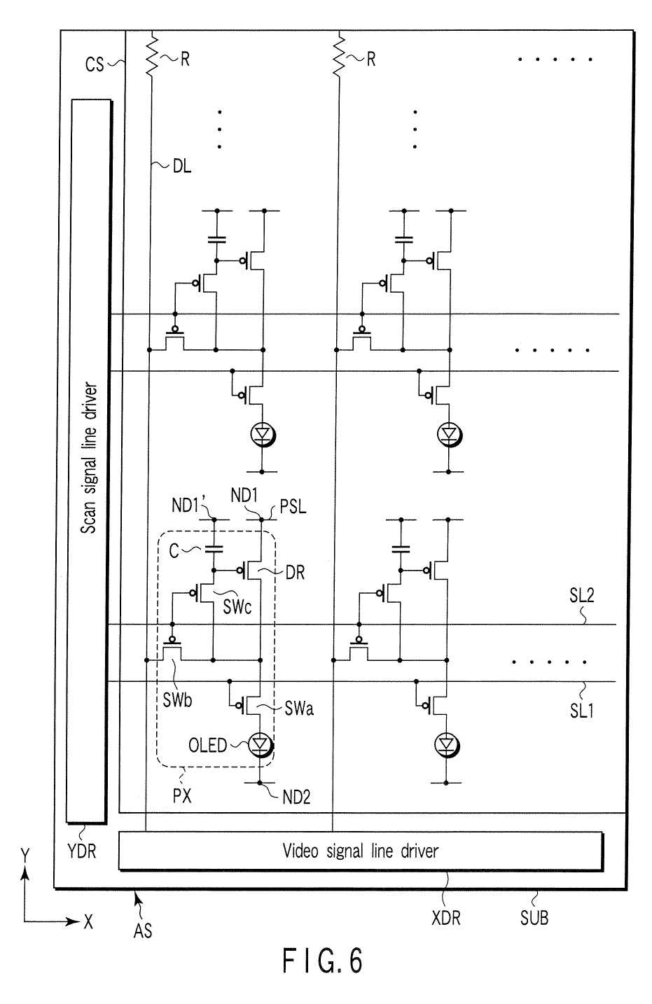

FIG. 6 is a plan view schematically showing a part of a display according to a third embodiment of the present invention. This display is a bottom emission organic EL display employing an active matrix driving method. The organic EL display has the same structure as that of the organic EL display shown in FIGS. 1 and 2 except that the analog switches SWd, inspection signal lines IL, and gate lines GL are omitted and that the array substrate AS further includes resistance elements R.

The resistance elements R are arranged correspondently with the video signal lines DL on a surface of the insulating substrate SUB which faces the sealing substrate CS, along the edge of the opposing surface of the insulating substrate SUB. One end of each resistance element R is located at the edge of the surface of the insulating substrate SUB which faces the sealing substrate CS. The other end of the resistance element R is connected to the video signal line DL.

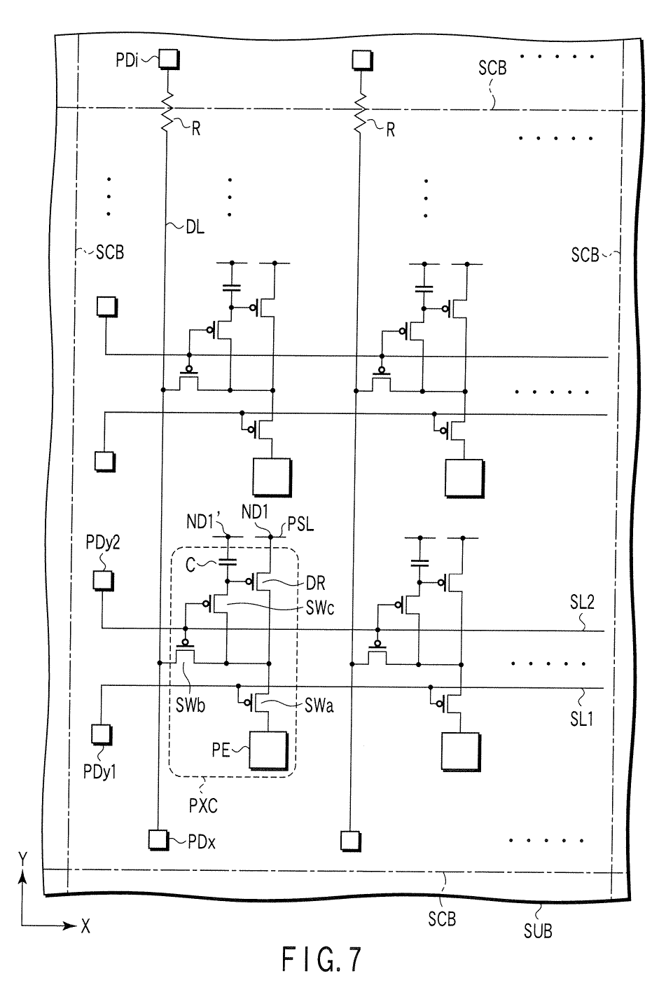

FIG. 7 is a plan view schematically showing an example of an array substrate that can be used to manufacture the display shown in FIG. 6. FIG. 7 shows an unbroken array substrate. The array substrate AS shown in FIG. 6 is obtained by breaking the array substrate shown in FIG. 7 along the breaking lines SCB.

When the array substrate shown in FIG. 7 is used, the organic EL display shown in FIG. 6 can be manufactured by, for example, the method described below.

Firstly, the array substrate shown in FIG. 7 is prepared, and the organic layers ORG and second electrode CE are sequentially formed on the first electrodes PE. Subsequently, the array substrate shown in FIG. 7 and the sealing substrate CS shown in FIG. 6 are laminated together via the sealing layer AD in an inert gas, for example. Then, the following dynamic operating inspection is performed on the resultant structure.

Scan signal output terminals of an inspection apparatus are brought into contact with the OLB pads PD_{y}1 and PD_{y}2, and inspection signal output terminals of the inspection apparatus are brought into contact with the inspection pads PDᵢ. Subsequently, an image is displayed by the method described in the first embodiment to determine whether a dot-like or line-like luminance unevenness occurs on the displayed image. As the output terminals of the inspection apparatus, hard contact pins may be used.

Then, the repair process described in the first embodiment is performed, if necessary. Subsequently, the array substrate AS is broken along the breaking lines SCB, and the video signal line driver XDR and scan signal line driver YDR are mounted on the broken array substrate AS. The display shown in FIG. 6 is thus obtained.

In this manufacturing method, the inspection pads PDᵢ are arranged on the outside of the breaking lines SCB. The inspection signals are fed to the inspection pads PDᵢ. Consequently, hard contact pins can be used as inspection signal output terminals of an inspection apparatus.

In the manufacturing method, the array substrate is broken such that a portion of the breaking lines SCB cuts across the resistance elements R. Therefore, the broken array substrate AS also includes the resistance elements R, though their electric resistances are smaller than those before breaking. Thus, according to the present embodiment, similarly to the first embodiment, electrostatic damage of the pixels PX is less prone to occur.

The resistance elements R have the function of preventing an overcurrent flow from the inspection apparatus into circuits in an active area. Therefore, according to the present embodiment, it is possible to more securely prevent the circuits in the active area from being damaged when the dynamic operating inspection is performed.

As the resistance elements R, for example, impurity semiconductor layers such as polysilicon layer containing an acceptor impurity or donor impurity may be used. As an example, when a conductive path having a certain dimensions and made of MoW has an electric resistance of 50 Ω, a conductive path having the same dimensions and made of n⁺-type polysilicon can have an electric resistance of about 0.2 MΩ.

In the first to third embodiments, the organic EL display employs a bottom emission structure. Instead, the organic EL display may employ a top emission structure. In the first to third embodiments, the pixels PX employ the circuits shown in FIGS. 1, 4 and 6. Instead, the pixels PX may employ other circuits.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising:
an insulating substrate;
a video signal line placed on a main surface of the insulating substrate and including first and second ends;
pixels connected to the video signal line;
a video signal line driver to which the first end is connected;
an inspection signal line placed near the second end and including third and fourth ends, the third end being located at an edge of the main surface; and
an analog switch connected between the second and fourth ends.

2. The display according to claim 1, further comprising a gate line including fifth and sixth ends, the fifth end being located at the edge, and the analog switch being a field-effect transistor whose gate is connected to the sixth end.

3. The display according to claim 1, further comprising:
a low-potential line;
a high-potential line; and
a protection circuit including a first diode which is connected between the low-potential line and the inspection signal line such that a forward current flows through the first diode from the low-potential line to the inspection signal line, and a second diode which is connected between the high-potential line and inspection signal line such that a forward current flows through the second diode from the inspection signal line to the high-potential line.

4. The display according to claim 3, wherein the first and second diodes are placed between the analog switch and the edge.

5. The display according to claim 1, wherein each of the pixels comprises:
a drive circuit connected to a first power supply terminal and the video signal line and configured to hold a video signal supplied from the video signal line driver via the video signal line and output a drive current at a magnitude corresponding to a magnitude of the video signal;
a display element including a pixel electrode, a counter electrode connected to a second power supply terminal, and an active layer interposed between the pixel electrode and the counter electrode; and
an output control switch connected between an output terminal of the drive circuit and the pixel electrode.

6. The display according to claim 1, wherein each of the pixels includes an organic EL element as a display element.

7. A display comprising:
an insulating substrate;
a video signal line placed on a main surface of the insulating substrate and including first and second ends;
pixels connected to the video signal line;
a video signal line driver to which the first end is connected; and
a resistance element placed near the second end and including first and second terminals, the first terminal being connected to the second end, and the second terminal being located at an edge of the main surface.

8. The display according to claim 7, wherein the resistance element is a polysilicon layer containing impurities.

9. The display according to claim 7, wherein each of the pixels comprises:
a drive circuit connected to a first power supply terminal and the video signal line and configured to hold a video signal supplied from the video signal line driver via the video signal line and output a drive current at a magnitude corresponding to a magnitude of the video signal;
a display element including a pixel electrode, a counter electrode connected to a second power supply terminal, and an active layer interposed between the pixel electrode and the counter electrode; and
an output control switch connected between an output terminal of the drive circuit and the pixel electrode.

10. The display according to claim 7, wherein each of the pixels includes an organic EL element as a display element.

11. An array substrate comprising:
an insulating substrate;
a video signal line placed on a main surface of the insulating substrate and including first and second ends;
pixel circuits connected to the video signal line;
an OLB pad connected to the first end;
an inspection signal line including third and fourth ends;
a first inspection pad connected to the third end; and
an analog switch connected between the second and fourth ends.

12. The array substrate according to claim 11, further comprising:
a control line, the analog switch being a field-effect transistor whose gate is connected to the control line; and
a second inspection pad connected to the control line.

13. The array substrate according to claim 11, further comprising:
a low-potential line;
a high-potential line; and
a protection circuit including a first diode which is connected between the low-potential line and the inspection signal line such that a forward current flows through the first diode from the low-potential line to the inspection signal line, and a second diode which is connected between the high-potential line and inspection signal line such that a forward current flows through the second diode from the inspection signal line to the high-potential line.

14. The array substrate according to claim 11, wherein each of the pixel circuits comprises:
a drive circuit connected to a first power supply terminal and the video signal line and configured to hold a video signal supplied from the video signal line and output a drive current at a magnitude corresponding to a magnitude of the video signal;
a pixel electrode; and
an output control switch connected between an output terminal of the drive circuit and the pixel electrode.

15. An array substrate comprising:
an insulating substrate;
a video signal line placed on a main surface of the insulating substrate and including first and second ends;
pixel circuits connected to the video signal line;
an OLB pad connected to the first end;
an inspection pad; and
a resistance element connected between the second end and the inspection pad.

16. The array substrate according to claim 15, wherein the resistance element is a polysilicon layer containing impurities.

17. The array substrate according to claim 15, wherein each of the pixel circuits comprises:
a drive circuit connected to a first power supply terminal and the video signal line and configured to hold a video signal supplied from the video signal line and output a drive current at a magnitude corresponding to a magnitude of the video signal;
a pixel electrode; and
an output control switch connected between an output terminal of the drive circuit and the pixel electrode.

18. A method of manufacturing a display, comprising:
preparing the array substrate according to claim 11;
forming pixels including the pixel circuits;
inspecting the pixels by supplying the first inspection pad with an inspection signal while closing the analog switch; and
breaking the array substrate along a break line which intersects the inspection signal line and is spaced apart from the analog switch and the video signal line.

19. The method according to claim 18, wherein the array substrate further comprises:
a control line including fifth and sixth ends; and
a second inspection pad connected to the fifth end,
wherein the analog switch is a field-effect transistor whose gate is connected to the sixth end, and
wherein breaking the array substrate is carried out such that the breaking line intersects the control line.

20. The method according to claim 18, wherein the array substrate further comprises:
a low-potential line;
a high-potential line; and
a protection circuit including a first diode which is connected between the low-potential line and the inspection signal line such that a forward current flows through the first diode from the low-potential line to the inspection signal line, and a second diode which is connected between the high-potential line and inspection signal line such that a forward current flows through the second diode from the inspection signal line to the high-potential line.

21. A method of manufacturing a display, comprising:
preparing the array substrate according to claim 15;
forming pixels including the pixel circuits;
inspecting the pixels by supplying the inspection pad with an inspection signal; and
breaking the array substrate along a break line which intersects the resistance element.
